(19) United States
(12) Patent Application Publication
(10) Pub. No.: US 2024/0309163 A1
(43) Pub. Date: Sep. 19, 2024

(54) FOAMED SHEET COMPRISING HIGH MELT STRENGTH POLYPROPYLENE

(71) Applicant: SABIC GLOBAL TECHNOLOGIES B.V., Bergen op Zoom (NL)

(72) Inventors: Peter Degenhart, Echt (NL); Martin Antonius van Es, Epen (NL); Mark Leo Hendrik Theunissen, Brunssum (NL); Maikel Renders, Valkenswaard (NL)

(21) Appl. No.: 18/277,801

(22) PCT Filed: Feb. 18, 2022
(86) PCT No.: PCT/EP2022/054065

§ 371 Date: Aug. 18, 2023

(30) Foreign Application Priority Data
Feb. 18, 2021 (EP) 21157928.9
Feb. 18, 2021 (EP) 21157932.1
Feb. 18, 2021 (EP) 21157935.4
Feb. 18, 2021 (EP) 21157966.9
Feb. 18, 2021 (EP) 21157969.3

(51) Int. Cl. C08J 9/00; C08J 5/18; C08J 7/12; C08J 9/14

(52) U.S. Cl. CPC C08J 9/0066; C08J 5/18; C08J 7/123; C08J 9/0061; C08J 9/141; C08J 2201/03; C08J 2203/14; C08J 2323/12; C08J 2323/18

(57) ABSTRACT

The invention relates to a foamed sheet comprising a polymer composition comprising a high melt strength polypropylene wherein the high melt strength polypropylene has a melt strength≥45 cN, preferably ≥50 cN, more preferably ≥55 cN, even more preferably ≥60 cN, most preferably ≥65 cN, wherein the melt strength is determined in accordance with ISO 16790:2005 at a temperature of 200° C., using a cylindrical capillary having a length of 20 mm and a width of 2 mm, a starting velocity v₀ of 9.8 mm/s and an acceleration of 6 mm/s².

The invention relates to a foamed sheet comprising a polymer composition comprising a high melt strength polypropylene, an article comprising said foamed sheet, as well as to a process for the preparation of said foamed sheet and the use of said foamed sheet.

Polymer foams are used in a wide range of applications, such as building and construction, automotive applications, household applications, such as food packaging and protective packaging; and consumer applications. Foams are popular because of their good mechanical rigidity, their good insulative properties and their cushioning against mechanical shock. In addition, the use of foams provides a significant contribution to the reduction in the use of raw materials. Moreover, the use of foams allows for a lightweight solution, which is not only of advantage from a cost perspective, but also from a transportation point of view as less energy is required to transport a lighter material.

Polypropylene foams are of advantage as compared to other polymer foams due to a number of reasons: polypropylene has good mechanical properties, in particular rigidity (stiffness), allows easy recycling (whereas, polystyrene for example requires further steps in waste separation processes), has a good chemical (oil and acid) resistance, a good thermal resistance and does not absorb water.

US2019/276653 A1 discloses a foamable composition including a polypropylene-based copolymer and a polyolefin.

US2020/087478A1 discloses a process for the production of a foam having low organic compounds emissions, to polypropylene foamed products obtainable by the process, and to a process for the manufacture of low organic compounds emission articles comprising a foam for use in cars and food packaging.

US2018/0201752A1 discloses cups based on a multi-layered sheet comprising at least one foamed layer based on high melt strength polypropylene and a nucleating agent.

US2004/0258902A1 discloses a foamed article comprising a polymer foam base layer having at least one outer face, said outer face containing over at least one area a plurality of integrally foamed surface microstructures comprised of voids, said microstructures having at least one dimension which is greater than 10 microns and the voids forming the foam having a mean cross-sectional dimension less than the smallest cross-sectional dimension of the microstructure.

In order to foam polypropylene, long chain branched polypropylenes are commonly used. An example of such long chain branched polypropylene is Daploy^{M} WB140HMS commercially available from Borealis.

However, there is a continuous desire to improve long chain branched polypropylenes. For example, it is desired to improve the processing, recyclability and/or properties of the foam produced with the long chain branched polypropylenes. Furthermore, there is also pressure to lower the environmental impact of the polypropylene foams, for example by further downgauging and/or increasing recyclability.

It is the object of this invention to achieve the preparation of foamed sheets having a higher bending stiffness while not increasing the environmental impact (that is while not increasing the amount of raw materials needed).

This object is achieved by a foamed sheet comprising a polymer composition comprising a high melt strength polypropylene wherein the high melt strength polypropylene has a melt strength≥45 cN, preferably ≥50 cN, more preferably ≥55 cN, even more preferably ≥60 cN, most preferably ≥65 cN, wherein the melt strength is determined in accordance with ISO 16790:2005 at a temperature of 200° C., using a cylindrical capillary having a length of 20 mm and a width of 2 mm, a starting velocity v₀ of 9.8 mm/s and an acceleration of 6 mm/s².

Foamed sheets of the invention show an increased overall bending stiffness. This means that the high melt strength polypropylene having a melt strength≥45 cN in the foamed sheets of the invention allows for a) the production of foams that have an increased bending stiffness (same thickness) and b) for the production of foams using less raw material, while still achieving the same bending stiffness (lower thickness and/or lower foam density). The use of less raw material (down-gauging is advantageous from an environmental point of view in terms of carbon footprint (less material and less transport costs and energy) as well as from an economical (cost) perspective.

A sheet as defined herein is a shape which has a longer length than width, and a larger width than thickness. The thickness of the sheet is in principle not critical, but may for example be ≥5 μm and ≤100 cm.

In the context of the invention, with ‘foamed’ or ‘foam’ is meant that the shape has a lower density due to the presence of gas bubbles (such as air) as compared to the density of the same material without gas bubbles.

### High Melt Strength Polypropylene Composition

High melt strength polypropylene having a melt strength≥45 cN can for example be obtained by the process as disclosed in WO2009/003930A1. WO2009/003930A1 discloses an irradiated polymer composition comprising at least one polyolefin resin and at least one non-phenolic stabilizer, wherein the irradiated polymer composition is produced by a process comprising mixing the polyolefin resin with the non-phenolic stabilizer and irradiating this mixture in a reduced oxygen environment. In addition, a high melt strength polypropylene having a melt strength≥45 cN is available from SABIC as SABIC® PP UMS 561P as of 18 Feb. 2021.

Preferably, the high melt strength polypropylene is prepared by
a) irradiation of a polypropylene with at least one non-phenolic stabilizer, preferably wherein the non-phenolic stabilizer is chosen from the group of hindered amines, wherein the irradiation is performed with ≥2.0 and ≤20 Megarad electron beam radiation in a reduced oxygen environment, wherein the amount of active oxygen is ≤15% by volume with respect to the total volume of the reduced oxygen environment for a time sufficient for obtaining a long chain branched polypropylene and
b) deactivation of the free radicals in the long chain branched polypropylene to form the high melt strength polypropylene.

How to deactivate the free radicals is known in the art, for example by heating as described in WO2009003930A1.

Examples of non-phenolic stabilizers are known in the art and are for example disclosed on pages 37-60 of WO2009/003930A1, hereby incorporated by reference. Preferably, the non-phenolic stabilizer is chosen from the group of hindered amines. More preferably, the non-phenolic stabilizer comprises at least one hindered amine selected from the group of Chimassorb® 944, Tinuvin® 622, Chimassorb® 2020, Chimassorb® 119, Tinuvin® 770, and mixtures thereof, separate or in combination with at least one hydroxylamine, nitrone, amine oxide, or benzofuranone selected from N,N-di(hydrogenated tallow)amine (Irgastab® FS-042), an N,N-di(alkyl)hydroxylamine produced by a direct oxidation of N,N-di(hydrogenated tallow)amine (Irgastab® FS-042), N-octadecyl-α-heptadecylnitrone, Genox™ EP, a di(C16-C18)alkyl methyl amine oxide, 3-(3,4-dimethylphenyl)-5,7-di-tert-butyl-benzofuran-2-one, Irganox® HP-136 (BFI), and mixtures thereof, and separate or in combination with at least one organic phosphite or phosphonite selected from tris(2,4-di-tert-butylphenyl) phosphite (Irgafos® 168). Even more preferably, the non-phenolic stabilizers of the present subject matter can include those described in U.S. Pat. Nos. 6,664,317 and 6,872,764, both of which are incorporated herein by reference in their entirety.

Preferably, the melt strength of the high melt strength polypropylene is ≥50 cN, more preferably ≥55 cN, even more preferably ≥60 cN, most preferably ≥65 cN and/or preferably the melt strength of the high melt strength polypropylene is ≤95 cN, for example ≤90 cN, for example ≤87 cN.

The melt strength of the high melt strength polypropylene is determined in accordance with ISO 16790:2005 at a temperature of 200° C., using a cylindrical capillary having a length of 20 mm and a width of 2 mm, a starting velocity v0 of 9.8 mm/s and an acceleration of 6 mm/s2.

With polypropylene as used herein is meant propylene homopolymer, a copolymer of propylene with an α-olefin or a heterophasic propylene copolymer.

Preferably, the high melt strength polypropylene is polypropylene chosen from the group of propylene homopolymers and propylene copolymers comprising moieties derived from propylene and one or more comonomers chosen from the group of ethylene and alpha-olefins with ≥4 and ≤12 carbon atoms.

Preferably, the propylene copolymer comprises moieties derived from one or more comonomers chosen from the group of ethylene and alpha-olefins with ≥4 and ≤12 carbon atoms in an amount of ≤10 wt %, for example in an amount of ≥1.0 and ≤7.0 wt % based on the propylene copolymer, wherein the wt % is determined using ¹³C NMR. For example, the propylene copolymer comprises moieties derived from one or more comonomer chosen from the group of ethylene, 1-butene, 1-pentene, 1-hexene, 4-methyl-1-pentene, 1-heptene, 1-octene, 1-decene and 1-dodecene, preferably moieties derived from ethylene.

Polypropylenes and the processes for the synthesis of polypropylenes are known. A propylene homopolymer is obtained by polymerizing propylene under suitable polymerization conditions. A propylene copolymer is obtained by copolymerizing propylene and one or more other comonomers, for example ethylene, under suitable polymerization conditions. The preparation of propylene homopolymers and copolymers is for example described in Moore, E. P. (1996) Polypropylene Handbook. Polymerization, Characterization, Properties, Processing, Applications, Hanser Publishers: New York.

Propylene homopolymers, propylene copolymers and heterophasic propylene copolymers can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems. All are, in themselves, known in the art.

Preferably, the high melt strength polypropylene has a VOC value as determined in accordance with VDA278 (2011-10)≤250 μg/g, preferably a VOC value≤50 μg/g and/or an FOG value as determined in accordance with VDA278 (2011-10)≤500 μg/g, preferably an FOG-value≤100 μg/g.

Preferably, the high melt strength polypropylene has a melt flow rate≥0.50 and ≤8.0 g/10 min, more preferably ≥0.70 and ≤5.0 g/10 min, most preferably ≥1.0 and ≤4.0 g/10 min, most preferably ≥1.5 and ≤4.0 as determined in accordance with ASTM D1238 (2013) at a temperature of 230° C. under a load of 2.16 kg.

Preferably, the high melt strength polypropylene is present in an amount ≥10 wt % based on the polymer composition, preferably wherein the high melt strength polypropylene is present in an amount ≥10 wt % based on the polymer composition, more preferably in an amount ≤99.5 wt % based on the polymer composition. For example, the amount of high melt strength polypropylene based on the polymer composition is ≥15 wt %, ≥20 wt %, ≥25 wt %, preferably ≥30 wt %, preferably ≥40 wt %, preferably ≥50 wt %, preferably ≥60 wt %, preferably ≥70 wt %, preferably ≥80 wt %, preferably ≥90 wt % and/or ≤99.5 wt %, ≤99 wt %, ≤98.5 wt %, ≤98.0 wt %, ≤97.0 wt %, ≤96.0 wt %, ≤95.0 wt %.

The polymer composition may further comprise additives, such as for example flame retardants, pigments, lubricants, slip agents flow promoters, antistatic agents, processing stabilizers, long term stabilisers and/or UV stabilizers. The additives may be present in any desired amount to be determined by the man skilled in the art, but are preferably present ≥0.001 wt % and ≤5.0 wt %, more preferably ≥0.01 wt % and ≤4.0 wt %, even more preferably ≥0.01 wt % and ≤3.0 wt %, even more preferably ≥0.01 wt % and ≤2.0 wt % based on the polymer composition.

In one embodiment, the polymer composition further comprises a further polypropylene, preferably a further polypropylene in an amount of ≥10 wt % and ≤40 wt % based on the foamed sheet. The further polypropylene can be a propylene homopolymer, a propylene copolymer, for example a copolymer of propylene with an α-olefin as described herein or a heterophasic propylene copolymer, for example a heterophasic propylene copolymer as described herein.

The polymer composition may further comprise a nucleating agent. A nucleating agent may be desired to increase the cell density and to modify the dynamics of bubble formation and growth. (Gendron, Thermoplastic foam Processing, 2005, page 209). The amount of nucleating agent may for example be ≥0.010 wt % and ≤5.0 wt %, for example ≥0.030 wt % and ≤4.0 wt %, for example ≥0.050 wt % and ≤3.0 wt %, preferably ≥0.10 wt % and ≤2.5 wt %, more preferably ≥0.30 wt % and ≤1.5 wt % based on the polymer composition, most preferably ≥0.50 wt % and ≤1.2 wt % based on the polymer composition.

Suitable nucleating agents include but are not limited to talc, silica and a mixture of sodium bicarbonate and citric acid. Other suitable nucleating agents include amides, for example azo dicarbonamide, amines and/or esters of a saturated or unsaturated aliphatic (C₁₀-C₃₄) carboxylic acid. Examples of suitable amides include fatty acid (bis)amides such as for example stearamide, caproamide, caprylamide, undecylamide, lauramide, myristamide, palmitamide, behenamide and arachidamide, hydroxystearamides and alkylenediyl-bis-alkanamides, preferably (C₂-C₃₂) alkylenediyl-bis-(C₂-C₃₂) alkanamides, such as for example ethylene bistearamide (EBS), butylene bistearamide, hexamethylene bistearamide, ethylene bisbehenamide and mixtures thereof. Suitable amines include or instance (C₂-C₁₈) alkylene diamines such as for example ethylene biscaproamine and hexamethylene biscaproamine. Preferred esters of a saturated or unsaturated aliphatic (C₁₀-C₃₄) carboxylic acid are the esters of an aliphatic (C₁₆-C₂₄) carboxylic acid. Preferably, the nucleating agent is chosen from the group of talc, sodium bicarbonate, citric acid, azodicarbonamide and mixtures thereof, more preferably, the nucleating agent is talc.

For the preparation of the foamed sheet, it may be desired to use a cell stabilizer. Cell stabilizers are permeability modifiers which retard the diffusion of for example hydrocarbons such as isobutane to create dimensionally stable foams. (Gendron, Thermoplastic foam Processing, 2005, pages 31 and 149) Preferred cell stabilizers include but are not limited to glycerol monostearate (GMS), glycerol monopalmitate (GMP), palmitides and/or amides. Suitable amides are for example stearyl stearamide, palmitide and/or stearamide. Suitable mixtures include for example a mixture comprising GMS and GMP or a mixture comprising stearamide and palmitamide. Preferably, in case a cell stabilizer is used, the cell stabilizer is glycerol monostearate or stearamide.

The amount of cell stabilizer to be added depends on desired cell size and the polymer composition used for the preparation of the foamed sheet. Generally, the cell stabiliser may be added in an amount ≥0.10 and ≤3.0 wt % relative to the polymer composition. Preferably, the polymer composition is present in the foamed sheet in an amount ≥95 wt % based on the foamed sheet. For example, the polymer composition is present in the foamed sheet in an amount ≥96 wt %, ≥97 wt %, ≥98 wt %, ≥99 wt %, ≥99.5 wt % based on the foamed sheet. The foamed sheet may also consist of the polymer composition.

Preferably, the density of the foamed sheet is ≤650 kg/m³ and ≥20 kg/m³, preferably ≤500 kg/m³ and ≥30 kg/m³, wherein the density is determined according to ISO 845 (2006).

Preferably, the foamed sheet has an open cell content of ≤15.0%, preferably ≤12.0%, more preferably ≤10.0%, even more preferably ≤7.0%, even more preferably ≤5.0%, even more preferably ≤4.0%, even more preferably 3.0%, even more preferably ≤2.0%, wherein the open cell content is determined according to ASTM D6226-10.

Processes for the preparation of polypropylene foams and foamed sheets are within the knowledge of the person skilled in the art. In such a process, a melt of a composition of the high melt strength polypropylene mixed with a gaseous or liquid blowing agent is suddenly expanded through a pressure drop. Continuous foaming processes as well as discontinuous processes may be applied. In a continuous foaming process, the polymer composition is melted and laden with gas in an extruder under pressures typically above 20 bar before being extruded through a die where the pressure drop causes the formation of a foam. The mechanism of foaming polypropylene in such foam extrusion process is explained, for example, in H. E. Naguib, C. B. Park, N. Reichelt, Fundamental foaming mechanisms governing the volume expansion of extruded polypropylene foams, Journal of Applied Polymer Science, 91, 2661-2668 (2004). Processes for foaming are outlined in S. T. Lee, Foam Extrusion, Technomic Publishing (2000). In a discontinuous foaming process, the polypropylene composition (micro-)pellets are laden with foaming agent under pressure and heated below melting temperature before the pressure in the autoclave is suddenly relaxed. The dissolved foaming agent forms bubbles and creates a foam structure.

Preferably the foamed sheet of the invention is prepared by a foam extrusion process.

In another aspect, the invention relates to a process for the preparation of the foamed sheet of the invention. In particular, the invention also relates to a process for the preparation of the foamed sheet of the invention, comprising the sequential steps of:
a) providing the polymer composition of any one of claims 1-9 and
b) adding a blowing agent to the polymer composition, for example wherein the blowing agent is added in an amount ≥0.10 wt % and ≤20 wt % based on the polymer composition and
c) subjecting the mixture of the polymer composition and the blowing agent to a foaming process, preferably a foam extrusion process to form the foamed sheet.

The amount of blowing agent for example depends on the desired density and the polymer composition used. For example, the blowing agent may be used in an amount ≥0.10 wt % and ≤20 wt % based on the polymer composition.

Examples of suitable physical blowing agents include, but are not limited to isobutane, CO2, pentane, butane, nitrogen and/or a fluorohydrocarbon. Preferably, the physical blowing agent is isobutane and/or CO2, most preferably isobutane.

Examples of suitable chemical blowing agents include, but are not limited to citric acid or a citric acid-based material (e.g. mixtures of citric acid and sodium bicarbonate) and azo dicarbonamide. Such chemical blowing agents are for example commercially available from Clariant Corporation under for example the name Hydrocerol™ CF-40E™ or Hydrocerol™ CF-05E™.

The foamed sheets thus prepared may be stretched monoaxially or biaxially using a manner known per se.

Therefore, the invention also relates to a process for the preparation of the foamed sheet of the invention, comprising the sequential steps of:
a) providing the polymer composition of the invention and
b) adding a blowing agent to the polymer composition, for example wherein the blowing agent is added in an amount ≥0.10 wt % and ≤20 wt % based on the polymer composition and
c) subjecting the mixture of the polymer composition and the blowing agent to a foaming process, preferably a foam extrusion process to form the foamed sheet and
d) stretching the foamed sheet in at least one direction.

The invention also relates to the foamed sheet of the invention, which foamed sheet is stretched in at least one direction, for example the invention relates to the foamed sheet of the invention, wherein the foamed sheet is monoaxially stretched (for example in the machine direction) or for example, the invention relates to the foamed sheet of the invention wherein the foamed sheet is biaxially stretched, for example in both the machine direction (MD) and in the transverse direction (MD). As is known to the person skilled in the art, the stretching in MD and TD may be carried out simultaneously, or in consecutive steps.

The draw ratio in MD may for example be ≥1.1 and ≤7.0, for example ≥1.1 and ≤3.0. The draw ratio in transverse direction may for example be ≥1.1 and ≤7.0, for example ≥1.1 and ≤3.0.

The sheets of the invention can suitably be used in applications such as building and construction, automotive applications, household applications, such as food packaging and protective packaging; and consumer applications. For example, the sheets can be used for the preparation of cups, trays, containers, bottles, seals, returnable boxes. Other applications of the sheets of the invention are for example: sandwich panels, pipe insulations, concrete joint fillers, insulation materials for houses, water tanks or floors (floor underlayments).

The very good cushioning properties of the foam of the invention offer the user safety and comfort. The foam is applicable in multiple applications requiring non-slip performance, such as footwear, protective guards, sports floor mats and foam rollers.

In another aspect therefore, the invention relates to an article comprising the foamed sheet of the invention. In yet another aspect, the invention relates to use of the foamed sheet of the invention in an applications such as building and construction, automotive applications, household applications, such as food packaging and protective packaging; and consumer applications.

The invention also relates to the use of the foamed sheet of the invention for the preparation of an article, for example wherein the article is a cup, tray, container, bottle, seal, reusable boxes, a sandwich panel, a pipe insulation, a concrete joint filler, an insulation material for houses, water tanks or floors (floor underlayments), footwear, a protective guard, a (sports) floor mat or a foam roller.

The sheets can be used as a replacement for applications wherein polystyrene foam is typically used, such as disposable food containers.

It is noted that the invention relates to the subject-matter defined in the independent claims alone or in combination with any possible combinations of features described herein, preferred in particular are those combinations of features that are present in the claims. It will therefore be appreciated that all combinations of features relating to the compositions according to the invention; all combinations of features relating to the processes according to the invention and all combinations of features relating to the compositions according to the invention and features relating to the processes according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

The invention is now elucidated by way of the following examples, without however being limited thereto.

### EXAMPLES

### Methods Used:

### Melt Flow Rate

The melt flow rate of the polymers was determined in accordance with ASTM D1238 (2013) at a temperature of 230° C. (MFR₂₃₀) under a load of 2.16 kg.

### Melt Strength

Melt strength was measured according to ISO standard 16790:2005. Melt strength is defined as the maximum (draw-down) force (in cN) by which a molten thread can be drawn before it breaks, e.g. during a Rheotens measurement. Measurements were done on a Göttfert Rheograph 6000 at a temperature of 200° C. with a setup like shown in FIG. 1 of ISO standard 16790:2005. The rheometer has an oven with a diameter of 12 mm. A capillary of 20 mm length and 2 mm width was used. The entrance angle of the capillary was 180° (flat). The piston in the rheometer moved with a velocity of 0.272 mm/s to obtain an exit velocity v0, of 9.8 mm/s. After filling the rheometer, the melt was held in the rheometer for 5 minutes, to stabilize the temperature and fully melt the polymer. The strand that exits the capillary was drawn with a Rheotens 11 from Goettfert with an acceleration of 6 mm/s² until breakage occurred. The distance between the exit of the capillary and the uptake wheels of the Rheotens II (=draw length) was 100 mm.

The pressure required to push the melted polymer through the capillary, the maximum drawing force (=Melt strength) and the maximum draw ratio at breakage were recorded.

### Flexural-Modulus

The flexural-modulus of samples of the foamed sheets was determined with a three-point bending test according to ISO1209-2 Rigid cellular plastics—Determination of flexural properties, using a testing speed of 20 mm/min. Samples having a span of 60 mm and a width of 20 mm were cut from the foamed sheets. The samples were cut in the machine direction (MD, extrusion direction) and in the transverse direction (TD, direction perpendicular to the extrusion direction and perpendicular to the thickness direction), such that the thickness of the foamed sheet (as indicated in Table 2) was maintained. As used herein, thickness direction is the size of the foamed sheet with the smallest dimension. Flexural modulus average is the average of the flexural modulus MD and the flexural modulus TD.

### Foam Density

Density of the foam (kg/m³) is the apparent overall density and was determined according to ISO 845:2006.

### Thickness and Width

Thickness and width of the foamed sheets were determined without applying pressure to the sheets.

### Open Cell Content

The open cell content was determined by using a Quantachrome Pentapyc 5200e gas pycnometer using a method based on ASTM D6226-10. The volume from the external dimensions of the sample was determined by using the Archimedes' principle by immersing the sample in water. It was assumed that the uptake of water by the sample can be neglected. After drying the sample from adhering water, the sample volume (V_{SPEC}) was determined by the pycnometer according ASTM D6226-10 at different pressures.

All applied pressures were below 0.1 bar to minimize compression of the foam.

$${V}_{SPEC} = {V}_{CHAMBER} - {V}_{EXP} / [ \frac{{P}_{1}}{{P}_{2}} - 1 ]$$

Where:
V_{SPEC}=Volume Sample
V_{CHAMBER}=Volume sample chamber
V_{EXP}=Expansion volume

The sample volume of the foam was plotted against the applied pressures (0.090 bar; 0.075 bar, 0.060 bar, 0.045 bar, 0.035 bar, 0.020 bar and 0.010 bar). A straight line was fit through the measurement points, using linear regression. The interception of the linear regression line with the Y-axis at p=0 bar is the volume (V_{SPEC_0}) used in equation below.

The open cell content Vₒₚₑₙ (%) was calculated using the following formula:

$${O}_{V} = [ ( V - {V}_{SPEC \_ 0} ) / V ] * 100$$

Where:
Oᵥ=open cell content [%]
V=Geometric volume
V_{SPEC_0}=Volume sample interpolated to a pressure of 0 bar

### Materials Used:

PP-UMS1 is a long chain branched propylene homopolymer which is commercially available from SABIC as SABIC® PPUMS 561P as of 18 Feb. 2021 without confidentiality restrictions, having a melt flow rate MFR₂₃₀ of 2.5 g/10 min and a melt strength of 71 cN. SABIC® PPUMS 561P has a VOC-value as measured in accordance with VDA278 (2011-10) within 7 days of its production of 10.9 μg/g. SABIC® PPUMS 561P has a FOG-value as measured in accordance with VDA278 (2011-10) within 7 days of its production of 56.4 μg/g.

PP-HMS is a long chain branched propylene homopolymer which is commercially available from Borealis as Daploy™ WB140HMS. It has a melt flow rate of MFR₂₃₀ of 2.2 g/10 min and a melt strength of 42 cN.

PP-UMS2 is an experimental long chain branched propylene homopolymer having a melt flow rate MFR₂₃₀ of 0.23 g/10 min and a melt strength of 62 cN. This PP-UMS2 is prepared as described in WO2009/003930A1, sample 11 (Polymer B) with 0.05 pph Genox EP.

Talc is TALCOLIN PP70+ which is a propylene homopolymer masterbatch with 70 wt % of talc (d50 of 9 μm), which is commercially available from JM Polymers.

Blowing agent is isobutane.

### Preparation of the Foamed Sheets

The preparation of the foamed sheets was performed on a 30 mm double screw foam extruder from Theysohn having a length over diameter ratio (l/d) of 40. This extruder consists of nine electrical heating zones equipped with water cooling followed by a cooling section, static mixer and a die. For CE5, it is expected that the temperature in front of the cooling section increases by approximately 5° C. relative to the experiments with PP-UMS1. Isobutane was added as a physical blowing agent in an amount of 2.5 wt % based on the composition of Table 1 and introduced in the polymer melt in the 8^{th} zone of the extruder. A slit die adjustable in thickness was used for the production of the foamed sheets. The die pressure was adapted by adjusting the thickness of the slit die such that the pressure at the die was 50 bar. A slit die having a width of 35 mm was used.

The foamed sheets were then stretched in machine direction at the draw ratio indicated in Table 2 using a double belt drawing unit. The thus obtained sheets were then cooled in a water cooled calibration unit to fix the dimensions of the prepared foamed sheets. The draw ratio was adjusted by adjusting the speed of the double belt unit to the exit speed of the foam at free expansion. At a draw ratio of 1, the exit speed of the foam at free expansion (vₑₓᵢₜ) equals the speed of the double-belt unit (v_{line-speed}).

Table 1 reports the polymer compositions, the foaming extrusion conditions and results.

### CONCLUSION

As can be seen from Table 1, when preparing foamed sheets in accordance with the invention, a higher flexural modulus average is obtained. The flexural modulus average is a measure for the overall bending stiffness.

The foamed sheets of the invention (containing a polymer composition based on a high melt strength polypropylene having a melt strength≥45 cN (E1-E4) show a higher overall bending stiffness than those sheets containing a polymer composition based on a high melt strength polypropylene having a melt strength<45 cN (CE1-CE4).

Therefore, the foamed sheets of the invention can be used for applications requiring a higher overall bending stiffness. For applications requiring the same overall bending stiffness, it is possible to use foamed sheets of the invention that are thinner and/or sheets that have a lower foam density. This so-called down-gauging is advantageous from an environmental point of view in terms of carbon footprint (less material and less transport costs and energy) as well as from an economical (cost) perspective.

Furthermore, foamed sheets of the invention prepared from a high melt strength polypropylene having a melt flow rate≥1.0 and ≤4.0 g/10 min, preferably ≥1.5 and ≤4.0 g/10 min as determined in accordance with ASTM D1238 (2013) at a temperature of 230° C. under a load of 2.16 kg will lead to a better surface appearance of the sheets (see examples E1-E4) as compared to sheets prepared from a high melt strength polypropylene having a melt flow rate of <1.0 g/10 min (see CE5 having a melt flow rate of 0.23 g/10 min).

Another advantage of the use of a high melt strength polypropylene composition having a melt flow rate≥0.5 and ≤8.0 g/10 min, preferably a melt flow rate≥0.70 and ≤5.0 g/10 min, more preferably a melt flow rate≥1.0 and ≤4.0 g/10 min, most preferably a melt flow rate≥1.5 and ≤4.0 g/10 min as determined in accordance with ASTM D1238 (2013) at a temperature of 230° C. under a load of 2.16 kg is that the extruder can be operated at a lower temperature as compared to CE5 where the temperature in front of the cooling section is expected to increase by approximately 5° C. as compared to E1-E4 and CE1-CE4. In commercial foam extruders, this increase of temperature is undesired as this limits the maximum throughput.

TABLE 1
polymer compositions used, foaming conditions and results

| | | | | | | | | |
|---|---|---|---|---|---|---|---|---|
| E1 | E2 | E3 | E4 | CE1 | CE2 | CE3 | CE4 | CE5 |

composition

| | | | | | | | | | | |
|---|---|---|---|---|---|---|---|---|---|---|
| PP-UMS1 | wt % | 97.9 | 97.9 | 97.9 | 97.9 | | | | | |
| PP-HMS | wt % | | | | | 97.9 | 97.9 | 97.9 | 97.9 | |
| PP-UMS2 | wt % | | | | | | | | | 97.9 |
| talc | wt % | 2.1 | 2.1 | 2.1 | 2.1 | 2.1 | 2.1 | 2.1 | 2.1 | 2.1 |

conditions

| | | | | | | | | | | |
|---|---|---|---|---|---|---|---|---|---|---|
| die pressure | bar | 50 | 50 | 50 | 50 | 50 | 50 | 50 | 50 | 50 |
| draw ratio | | 1 | 1.31 | 1.63 | 1.95 | 1 | 1.34 | 1.66 | 1.95 | 1 |
| line speed | m/min | 7.5 | 9.9 | 12.3 | 14.7 | 7.3 | 9.8 | 12.2 | 14.3 | 5 |

results

| | | | | | | | | | | |
|---|---|---|---|---|---|---|---|---|---|---|
| density | kg/m³ | 100 | 100 | 100 | 100 | 100 | 100 | 100 | 100 | 100 |
| thickness | mm | 2.3 | 2.0 | 1.9 | 1.6 | 2.5 | 2.2 | 1.9 | 1.8 | 2.5 |
| width | mm | 112 | 91 | 79 | 74 | 95 | 83 | 77 | 71 | 95 |
| flexural modulus | MPa | 88 | 106 | 142 | 159 | 90 | 120 | 135 | 163 | |
| MD | | | | | | | | | | |
| flexural modulus | MPa | 54 | 50 | 36 | 45 | 42 | 30 | 27 | 21 | |
| TD | | | | | | | | | | |
| flexural modulus | MPa | 71 | 78 | 92 | 104 | 66 | 75 | 82 | 93 | |
| average | | | | | | | | | | |
| surface | | + | + | + | + | + | + | + | + | − |
| appearance | | | | | | | | | | |

+: surface of the sheets was smooth
−: surface of the sheets expected to be uneven

1. Foamed sheet comprising a polymer composition comprising a high melt strength polypropylene wherein the high melt strength polypropylene has a melt strength≥45 cN, or ≥50 cN, or ≥55 cN, or ≥60 cN, or ≥65 cN, wherein the melt strength is determined in accordance with ISO 16790:2005 at a temperature of 200° C., using a cylindrical capillary having a length of 20 mm and a width of 2 mm, a starting velocity v0 of 9.8 mm/s and an acceleration of 6 mm/s2.

2. Foamed sheet according to claim 1, wherein the melt strength of the high melt strength polypropylene is ≤95 cN, or ≤90 cN, or ≤87 cN.

3. Foamed sheet according to claim 1, wherein the high melt strength polypropylene is chosen from the group of propylene homopolymers and propylene copolymers comprising moieties derived from propylene and one or more comonomers chosen from the group of ethylene and alpha-olefins with ≥4 and ≤12 carbon atoms.

4. Foamed sheet according to claim 1, wherein the high melt strength polypropylene has a melt flow rate≥0.5 and ≤8.0 g/10 min, or a melt flow rate≥0.70 and ≤5.0 g/10 min, or a melt flow rate≥1.0 and ≤4.0 g/10 min as determined in accordance with ASTM D1238 (2013) at a temperature of 230° C. under a load of 2.16 kg.

5. Foamed sheet according to claim 1, wherein the high melt strength polypropylene is prepared by
a) irradiation of a polypropylene with at least one non-phenolic stabilizer, wherein the non-phenolic stabilizer is chosen from the group of hindered amines, wherein the irradiation is performed with ≥2.0 and ≤20 Megarad electron beam radiation in a reduced oxygen environment, wherein the amount of active oxygen is ≤15% by volume with respect to the total volume of the reduced oxygen environment for a time sufficient for obtaining a long chain branched polypropylene and
b) deactivation of the free radicals in the long chain branched polypropylene to form the high melt strength polypropylene.

6. Foamed sheet according to claim 1, wherein the high melt strength polypropylene is present in an amount ≥10 wt % based on the polymer composition, wherein the high melt strength polypropylene is present in an amount ≥10 wt % based on the polymer composition, or in an amount ≤99.5 wt % based on the polymer composition.

7. Foamed sheet according to claim 1, wherein the polymer composition further comprises a further polypropylene.

8. Foamed sheet according to claim 1, wherein the polymer composition further comprises a nucleating agent, wherein the nucleating agent is present in an amount ≥0.01 wt % and ≤5.0 wt % based on the composition and/or wherein the nucleating agent is the nucleating agent is chosen from the group of talc, sodium bicarbonate, citric acid, azodicarbonamide and mixtures thereof.

9. Foamed sheet according to claim 1, wherein the polymer composition further comprises ≥0.001 wt % and ≤5.0 wt % additives based on the polymer composition.

10. Foamed sheet according to claim 1 wherein the polymer composition is present in the foamed sheet in an amount ≥95 wt % based on the foamed sheet.

11. Foamed sheet according to claim 1, wherein the density of the foamed sheet is ≤650 kg/m3 and ≥20 kg/m3, wherein the density is determined according to ISO 845 (2006) and/or wherein the foamed sheet has an open cell content of ≤15.0%, wherein the open cell content is determined according to ASTM D6226-10.

12. Foamed sheet according to claim 1, wherein the foamed sheet is prepared by a foam extrusion process.

13. Foamed sheet according to claim 1, wherein the polymer composition is present in the foamed sheet in an amount ≥95 wt % based on the foamed sheet and/or wherein the amount of high melt strength polypropylene based on the polymer composition is ≥15 wt %, ≥20 wt %, ≥25 wt %, or ≥30 wt %, or ≥40 wt %, or ≥50 wt %, or ≥60 wt %, or ≥70 wt %, or ≥80 wt %, or ≥90 wt %.

14. Article comprising the foamed sheet of claim 1.

15. Process for the preparation of the foamed sheet of claim 1, comprising the sequential steps of:
a) providing the polymer composition of claim 1 and
b) adding a blowing agent to the polymer composition, wherein the blowing agent is added in an amount ≥0.10 wt % and ≤20 wt % based on the polymer composition and
c) subjecting the mixture of the polymer composition and the blowing agent to a foaming process, and a foam extrusion process to form the foamed sheet and optionally
d) stretching the foamed sheet in at least one direction.

16. Use of the foamed sheet of claim 1 for the preparation of an article.
